(19) United States
(12) Patent Application Publication
(10) Pub. No.: US 2014/0195650 A1
(43) Pub. Date: Jul. 10, 2014

(54) Digital Media Objects, Digital Media Mapping, and Method of Automated Assembly

(71) Applicant: 5th Screen Media, Inc., Scotts Valley, CA (US)

(72) Inventor: Keith Kelsen, Scotts Valley, CA (US)

(73) Assignee: 5th Screen Media, Inc., Scotts Valley, CA (US)

(21) Appl. No.: 14/106,474

(22) Filed: Dec. 13, 2013

Related U.S. Application Data
(60) Provisional application No. 61/738,956, filed on Dec. 18, 2012.

(51) Int. Cl. H04L 29/08; G06F 17/30

(52) U.S. Cl. CPC H04L 67/02; G06F 17/30598
USPC 709/219

(57) ABSTRACT

A system and methodology for automatically assembling digital media objects located in a data base and transmitting the completed assembled media message via a network to a display based on the attributes of that particular type of display classification, whether it is a movie display screen, television display screen, personal computer display screen, mobile phone display screen, digital signage display screen, kiosk display screen or any other type of display screen that is known or unknown.

### CROSS-REFERENCE TO RELATED APPLICATIONS

This application claims the benefit of U.S. Provisional Application No. 61/738,956 filed Dec. 18, 2012, the content of which is incorporated by reference in its entirety for all purposes.

### BACKGROUND OF THE INVENTION

As one looks across the digital landscape, one finds oneself faced with many “screens” displaying media to users, for example, movies, television, personal computers, tablets, telephones, digital signage, or Digital Out Of Home. Of course users also are exposed to print. Each presentation has its own eco-system, business models, audience, purpose, technology, and content. Although new in relative terms to the other screens, digital signage is no exception. The way in which one can look at these differences can actually cause one to see the similarities at the very core of their existence. They are all communication vehicles, but one important distinguishing characteristic is the mindset with which they are viewed and interacted.

What is changing however, are two significant trends that directly affect how one interacts with each screen and how one creates content for each screen. Viewers now are engaging with every screen. This is brought on by technology that was born recently. From the simple interaction to very sophisticated and technologically impressive means to keep the viewer connected to every screen and even in virtual worlds. One can envision a world where our screens are as seamless as the streaming digital landscape that we find ourselves in. It is this seamlessness and connectedness that technology is just beginning to affect us. Connecting all five screens technologically is a trend that will find new ways to keep the audience turned on and tuned in with every screen.

Relevant media with which to interact play an important role in the digital technology world of today. This core issue of creating media is the most significant challenge among brands, agencies, creative, and educators and students alike. In addition one must reach beyond the screens and consider other aspects that are critical to creating effective media in our digital world, virtual reality and user generated content. Both have significant impact on consumer engagement, education and advertising effectiveness.

Throughout the years we have added each type of display method. First there was Motion Pictures (movies) with a movie production team to create a motion picture. Even today each movie is created purposefully be displayed on the movie screen. All media is normally created specifically for each type of display. There are television creative production teams that create programs and advertising for the Television display screens. There are web pages and media created specifically for viewing on a PC and tablet display screens via the World Wide Web. There is media created to be viewed specifically on a Mobile Cellular display screens. There is media created specifically to be displayed on digital signage displays.

A display type is typically configured to receive information for display via a communication network, which is configured to communicate with the displays communication system. The communication network typically includes wired communication networks, wireless communication networks, or a combination thereof.

Displays vary in size and may be about ten centimeters across to a few meters across or larger and display both projected still images and moving images. The creation of media for each type of display is usually designed to maximize the attributes of the display type and the experience that the viewer will have. A media creator, typically a human creator, of the media is focused on one type of display at a time while creating specific media formatted for that display type. Each display type has a process for creating media. The end result of creating media for the specific type of display is to ensure the viewer expected experience matches to the type of display the viewer is watching. To create media for each screen specifically is a costly method for creating media for display on each type of screen.

### BRIEF SUMMARY OF SELECT EMBODIMENTS

This invention relates to a database of digital media objects and method of having automated assembly use thereof. More particularly, embodiments of the present invention relate to a digital database and a digital media server where the display of digital media objects assembled are configured to communicate via a communication network to provide automated assembly, delivery, and display of media messages to create the proper end user digital experience based on the type of display method.

While creation of the media varies greatly and usually involves creating the media for one type of screen, there is one technique is different and is designed to carry the same message and media across all different type of displays. The purpose is to create media in bite size or granular Media Objects. These Media Objects reside in a database and then can be accessed by a human and can be assembled manually in a predetermined manner for the specific display, Movie, TV, PC, Tablet, Mobile or Digital Signage to create a final informational, entertainment, or advertising finished media message. This method is more cost effective than creating media specifically for each display type. The issue is that each finished assembled media message has to be manually assembled by a human. The additional problem is that even when the media is assemble into a cohesive message it is not possible to individualize the experience for a single viewer manually on a per display type basis.

Displays can include still image, video, animation, 3D, projected and holographic display systems for displaying information to viewers. Displays are configured to be in the following known categories; Movie Screen Projected Displays, Television Displays, Personal Computer Displays, Digital Tablet Displays, Cellular Mobile Phone Displays, Digital Signage Displays and Kiosk Displays. Digital Media is created to be displayed on the known display categories, but is not limited to these known categories.

The present invention in general relates to creating media objects that can be played on any type of display by means of Media Mapping of the Media Objects into a final media message to a specific display category or type. More particularly, embodiments of the present invention relate to a data base and media server where the network is configured to communicate via a communications network to provide automated completed media messages in the form of ads, information and entertainment that is made up of automatically assembled Media Objects for viewing on a specific type of display whether it is Movie, Television, PC, Tablet, Mobile, Digital Signage or Kiosk, whereas each type of display has its own characteristics for which the Media Objects are automatically Media Mapped into a complete media message and delivered to each type of display.

According to a specific embodiment of the present invention, each display type has certain characteristics that when the viewer is watching the displayed content, the experience changes based on which type of display the viewer is watching, therefore when one creates a database of small bits of media objects and the content server delivers an automated assembly of small bits of media objects that are mapped to a display using metadata so that when assembled automatically according to the display type then the viewer can watch and interact with an experience that is characterized for that particular display. Whereas if the viewer saw and advertisement on the Movie Display, a Television, on a PC, on a Tablet, on a mobile phone device and a digital signage, the campaign message and visuals would be similar for each particular display, with exception that the message for each display type would be altered to the characteristics of that particular display. Each finished media message, advertisement, informational piece or entertainment piece would be customized in an automated way while using the same media objects automatically assembled in different ways according to the type of display.

According to a specific embodiment of the present invention, each of the media objects would have metadata attached within its file base that is media mapped with the type of display that is being watched. The content server will check with each display to see what type of display is requesting the finished content piece. Once the content server understands which display type the finished content will be displayed on. The finished content is assembled from media objects that have the proper metadata embedded in the file for that particular display. Therefor each media object will be mapped to the display type using metadata tags which determine if that media object is suitable to playback on that particular display type. The set of metadata includes display type data, geographic metadata, and demographic metadata and any other metadata that may help to automatically assemble and send the complete set of media objects from the server to the correct display type.

According to a specific embodiment of the media system, the content server is configured to receive a supplemental set of metadata in a communication signal. The supplemental set of metadata is related to the type of the display and/or the location of the display and/or the demographic information of people who view the screen. The processor is configured to request this metadata to deliver the right media objects in a completed media message to the right audience and individual viewer.

According to another specific embodiment of the media system, the content server is configured to be coupled to a communication system via a network. The server is configured to serve the media to the communication system via the network for further serving of the media to the transceiver on a display via the communication signal that delivers the media.

According to a specific embodiment of the media system, the content server software that contains metadata that relates to specific media that has attributes to map media directly according to its specific use to the type of display. For instance, in utilizing digital signage networks the displays are deployed using specific business model and network types. In the digital signage networks there are displays used in three types of networks that media object can be media mapped to the particular use. The three are Point of Wait, Point of Sale and Point of Transit. Each of these types of networks requires specific media to playback that match the use of the display on that type of network.

According to another specific embodiment of the media system, it learns the attributes of the type of screen through a software artificial intelligence program that is programed to learn specific attributes about each classified type of display and recognizes each type of display and automatically assembles media objects to meet the user experience based on the display classification, type and use.

According to a specific embodiment of the media system, it learns (using artificial intelligence software) the attributes of each media object and cohesively merges media objects to create a media message that is coherent to the viewer, based on the message objectives and the display classification, type and use and the individual viewer characteristics. One of the benefits of at least one embodiment of the present invention is that displayable information and media that are relevant to viewers of the display are provided information that is relevant to the viewers without the viewer having to request the displayable information and/or media. Another advantage is that the display can be virtually anywhere in the world where communications, such a cellular telephone communication, are provided and receive relevant information for viewers on a particular display without having to be connected to a network, which adds to the ease of mobility and use of the system. In addition by automating the media mapping process, it creates a more efficient manner to assemble the media objects, requiring less man power and skill. Also as the media system learns more about the display classification, type and use and learns more about each media object that is entered into the media system it becomes more intelligent about delivering a cohesive media message that is relevant to the viewer based on the objectives of those who program and enter the media objects.

These and other advantages of embodiments of the invention will be apparent to those of skill in the art with reference to the remainder of the following detailed description and the accompanying figures.

### BRIEF DESCRIPTION OF THE DRAWINGS

FIG. 1 is a simplified schematic of a database of media objects and how the media mapping is coordinated to various display.

FIG. 2 is a high level schematic of the database of media objects and how each object is meta tagged with information pertaining to which display devices could accept that particular media object and assemble it in a particular order to create a complete media message.

FIG. 3 is a high level schematic of the media mapping that can be done for digital signage display in an automated manner. Whereas the type of network is identified as a Point of Sale digital signage network with displays in the store to help shoppers buy something. Once identifying the type of network then the system will identify the media objects that are in the digital asset management system that will automatically be assembled to populate a product template that is then mapped into another predesigned template that can accept media objects and media templates onto the display in the pre-determined designed position.

FIG. 4 is a high level schematic of the media system that show how the system can learn from input of viewers and display information and media object metadata and then make intelligent choices to fulfill the objectives of the media message and deliver it to a specific display classification, type and use and to specific attributes of an individual viewer.

FIG. 5 illustrates the Digital Media engine Ingest work flow.

FIGS. 6 and 7 illustrate media objects.

FIG. 8 is another illustration of media mapping.

FIG. 9 illustrates media mapping for DOOH home.

FIG. 10 illustrates a module for media mapping for PC/Internet.

FIG. 11 illustrates the media mapping planner module.

FIG. 12 illustrates the augmented reality and virtual world module.

FIG. 13 illustrates the media ad flow process.

FIG. 14 illustrates a prior art process.

FIG. 15 illustrates another prior art process.

FIG. 16 illustrates a media ad flow process.

FIG. 17 illustrates ad id labeling.

FIG. 18 illustrates ad id labeling.

FIG. 19 illustrates the digital media engine architecture.

FIG. 20 illustrates the digital media engine creative ad flow.

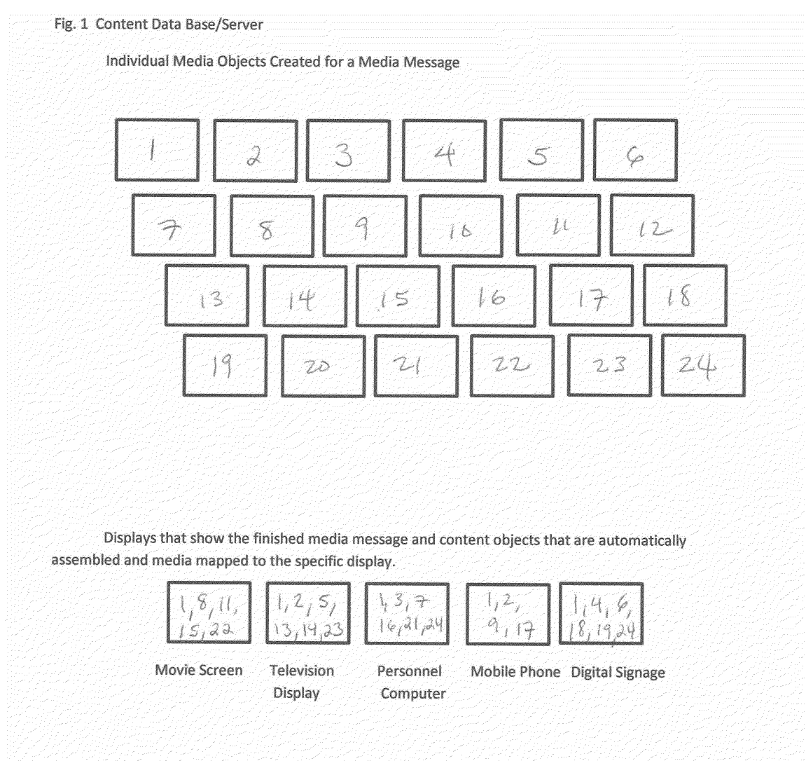

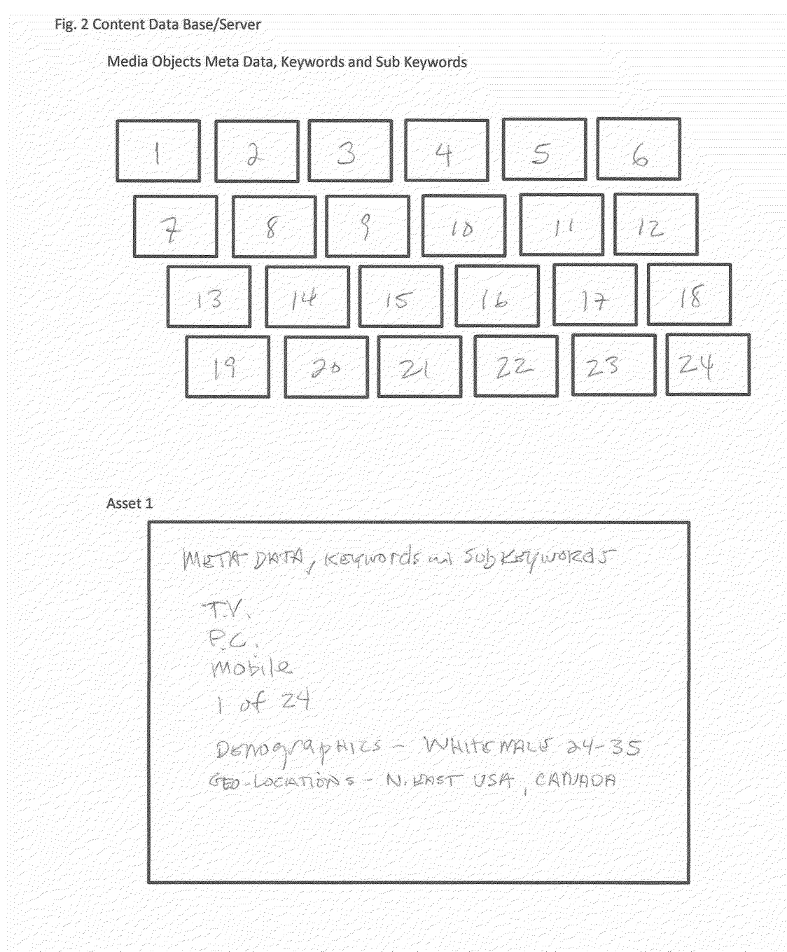

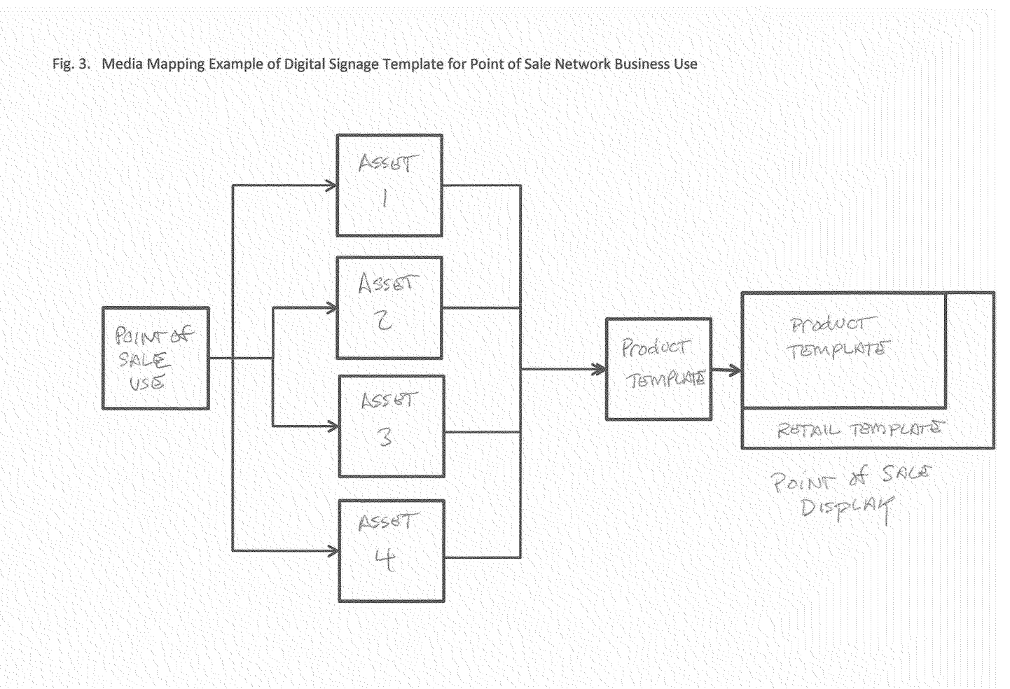

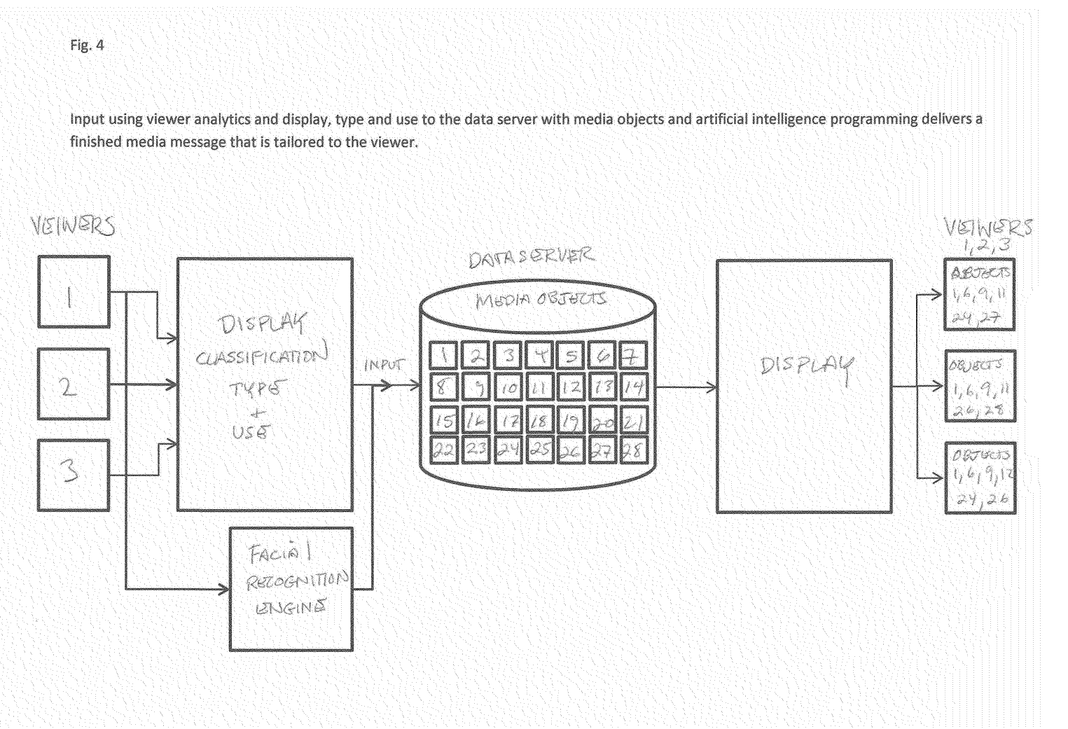

### DETAILED DESCRIPTION OF SPECIFIC EMBODIMENTS

The present invention relates to creating media objects that can be played on any type of display. More particularly, embodiments of the present invention relate to a data base and content server where the network is configured to communicate via a communications network to provide automated completed media messages, information and entertainment that is made up of automatically assembled media objects for display on a specific type of display whether it is Movie, Television, PC, Mobile or Digital Signage whereas each type of display has its own characteristics for which the media objects are assembled for. Also the system can identify the viewer by demographic, geographic, age, income and other sources of data gathered on the viewer. In addition the system learns from input and will make decisions based on more data gathered to create an intelligent media message that changes over time and individual characteristics of the viewer and viewer type.

The remaining portion of this document describes the architecture and design for a “Digital Media Engine” (DME) to address the issues of creation and delivery of media across any platform and across any reality for both user generated and professionally created media.

The Digital Media Engine is designed as a tool to address the very significant problem of creating and delivering media for the newly arrived digital world. There are three basic components to the Digital Media Engine (DME); Media Ingest, Media Objects, and Media Mapping. Media Ingest is the process by which media is ingested into the system in small granular bites size pieces while paying close attention to the creative process. Media Objects are the individual granular bite size media pieces themselves whether they are text, sound or visual. Media Mapping is how the media objects are related to an existing screen or to a virtual environment to create a final message or experience. Utilizing these three concepts one can create media using efficient protocols to address all screens and digital experiences in a universal manner that transcends the screen and produces a true “transmedia experience.”

The DME will address the problems associated with creating media within silo mind sets. Typically media within the agency/brand world is created in silos for the type of screen that is associated with. The DME is designed to move small bites size digital files through stages of creative production and to assemble the final message to airplay with integration to business systems. Throughout the years we have added each type of display method. First there was Motion Pictures (movies) with a movie production team to create a motion picture. Even today each movie is created to purposefully be displayed on the movie screen. All media is normally created specifically for each type of display. There are television creative production teams that create programs and advertising for the Television display screens. There are web pages and media created specifically for viewing on a PC and tablet display screens via the World Wide Web. There is media created to be viewed specifically on a Mobile Cellular display screens. There is media created specifically to be displayed on digital signage displays.

### Media Ingest

The creation of media for each type of display is usually designed to maximize the attributes of the display type and the experience that the viewer will have. A media creator, typically a human creator of the media, is focused on one type of display at a time while creating specific media formatted for that display type. Each display type has a process for creating media. The end result of creating media for the specific type of display is to ensure the viewer expected experience matches to the type of display the viewer is watching.

While creation of the media varies greatly and usually involves creating the media for one type of screen, the DME is designed to enhance one technique that is different and is designed to carry the same message and media across the 5 different types of displays and into multiverse experiences. The DME is a combination of a digital media asset management system, process work flow system, and delivery system of final messages. The DME will be compatible with current tools and systems to create and deliver final messages.

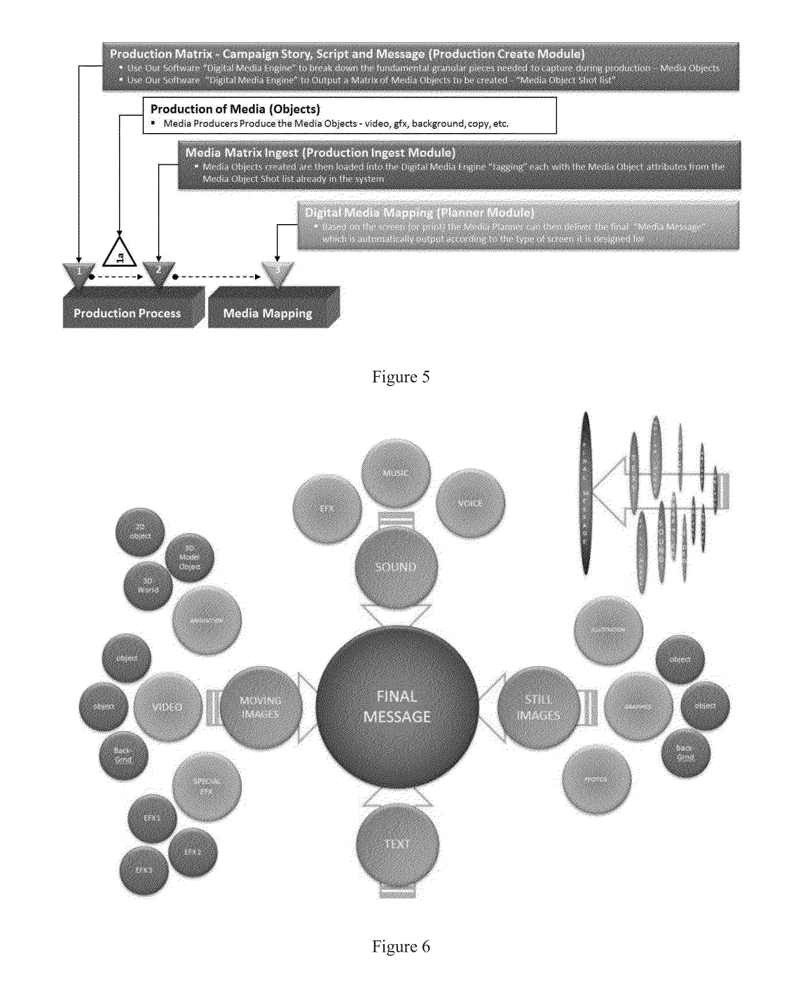

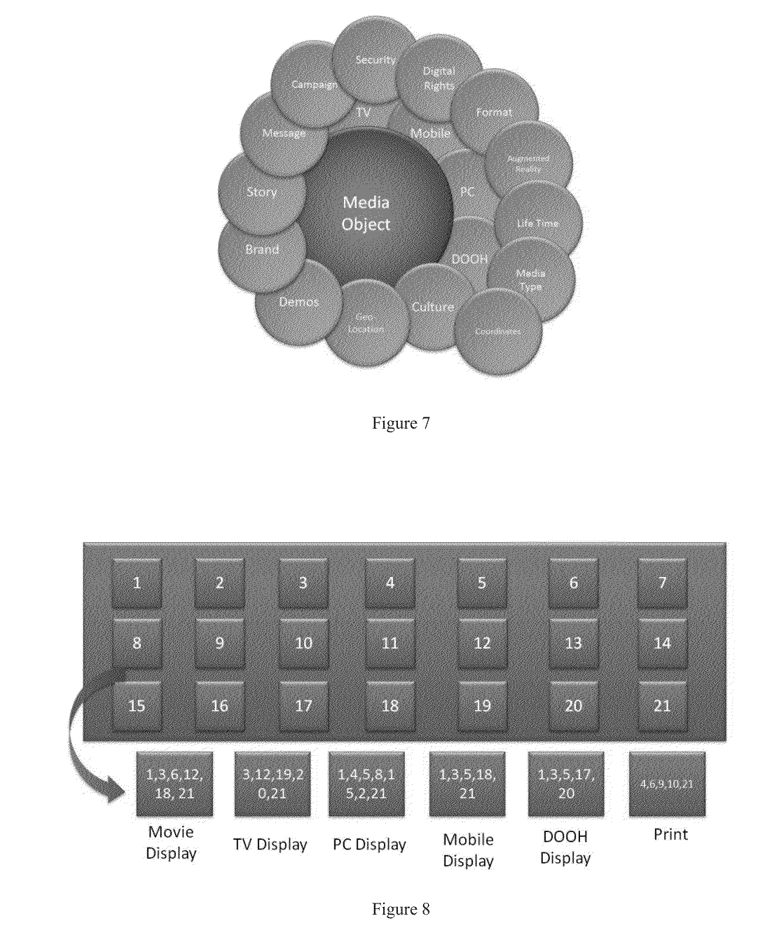

FIG. 5 illustrates the Digital Media engine Ingest work flow. Digital Media Engine Ingest Work Flow assists in the breakdown of story and message into fine granular bite size pieces of media called Media Objects. This work flow separates the platform from the story and message. The DME then provide a matrix shot list of all assets that need to be created while providing metadata on each object. Once the assets are created the production team inputs the media into the DME and each piece of Media is associated with metadata and the Media Object is created.

“The volume of content has dramatically increased. The combined increases in the amount of commercial video content and the explosion of distribution channels and delivery platforms has led to a multiplier effect on overall content volume. Asset identification and tracking have not kept pace. Key business applications, technologies and supporting operational processes have not scaled commensurate with the content explosion. Fundamentals of trade between entities are still operating on models developed decades ago.”—Ernst & Young, CIMM Study 2011

### Media Objects

Media will be created in bite size or granular Media Objects with DME acting as the tool to guide the workflow process production of media and store the media for easy access. These Media Objects reside in the DME and then can be accessed by a human and manually authored in a either a predetermined manner or free form for the specific display, Movie, TV, PC, Mobile or Digital Signage to create a final finished Media Message.

Using a Ingest Matrix process, the DME outputs a granulated “shot list” for the production of the media based on the characteristics of the final media message. This process and work flow will allow a creative producer to break down the script and story boards into fine granular Media Objects that will be categorized according type of media needed (text, gfx, video etc.) separated from the platform the final message will be delivered on. The creative producer will take the output granulated “shot list” and acquire the media to meet the needs of the final message regardless of the display platform desired.

Each Media Object is a separately acquired bites size media asset. Once the media is acquired the media is then ingested into DME and automatically tracked and meta-tagged according to the original granulated “shot list.” Media Objects are identified within the system based on the meta-tag according to the platform that the Media Object will be used for and based on demographic and geographic choices for made for each Media Object. Some Media Objects will be used for multiple platforms a meta-tagged accordingly.

The Media Objects are designed to be layered into a final media messages using both linear and non-linear methods. Media Objects are small, bite size and granular. Control of certain elements of the Media Object will also be possible based on the type of Media Object it is. For instance if the Media Object is text then one can easily modify the text within the DME and saved as a new Media Object retaining the parent attributes of the original. If a Media Object is a graphic then adjustments in the color will be available to a creative editor to fine tune the final message.

FIG. 6 illustrates media objects. Typical media objects are digital objects such as: (a) Text XML; (b) visual still images such as photos, bit graphics, and scalable vector graphics and (c) visual moving images, such as video, animation (e.g. 2D modeling and 3D Modeling (either with models or texture mapping), and special effects. Media objects further include audible objects such as voice, music and effects.

Media Objects have attributes as part of their embedded metadata. Attributes, for example, include: type of screen to be displayed on, demographic information, cultural set, geolocation, multiverse set, brand attributes, story and campaign, message attributes, security, rights management and format attributes.

Media Object naming convention will be identified by the system in intuitive easily grasped concepts that are primarily visual. First and foremost the Media Object will associated with the project, then by type of media, and then by the scene description, and then by granulated Media Object number with description. The visual reference ICON to easily ID the Media Object will be automated according to media type and the image within the ICON will be automated or can be manually chosen.

The meta-data associated with the Media Object allows global searches for Media Objects throughout the life of the project and future searches for Media Objects that may relate to future projects. Imagine having a sea of Media Objects at your fingertips that are relevant to a particular brand. This digital library of Media Objects will grow over time and become more useful to a brand or user to access in the future to create new final messages without re-creating the media itself. The Media Objects from the system can also be output to standard editing tools used for creation of linear messages like television.

The additional problem is that even when the Media Objects are assembled into a cohesive final message it is not possible to individualize the experience for a single viewer manually on a per display type basis. The DME allows the Media Objects to be assembled in an automated manner in which using measurement tools like Anonymous Video Analytics (AVA) and personal “opted in” information to understand the demographic, cultural and geolocation of the viewer to tailor more relevant messages and deliver an engaging experience.

The final messages must be compatible for delivery to any platform. The creative process for the final messages must be compatible with current standards used in the creative process and rendering of the final message. The Media Objects have the ability to use not only in traditional media messaging but also in Reality/Virtual experiences.

### Media Mapping

Media Mapping is a combination of identifying the relationship of the display type and the Media Object and identifying the final message configuration based on the display type, demographic, geographic, cultural set or multiverse use. Media Mapping allows Media Objects to be able to be automatically or manually authored to create the final message. Specific Media Mapping to each type of display is the driving action of each Media Object that is assembled for a specific display or multiverse experience. FIG. 8 is another illustration of media mapping

### Media Mapping DOOH

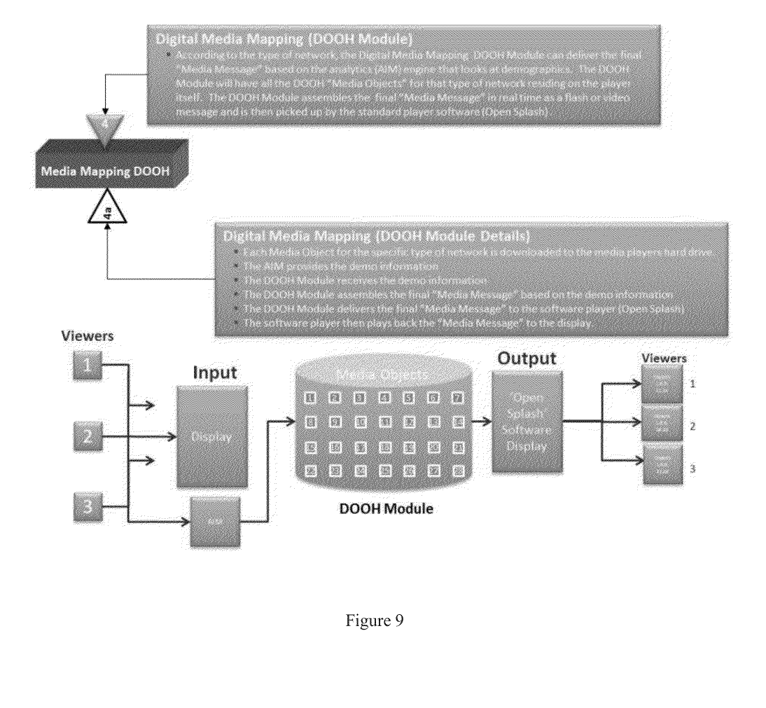

Media Mapping for DOOH home is a module that addresses the issues of creating a final message from the Media Objects for DOOH or Digital Signage that is relevant and appropriate for the specific type of network. This is illustrated in FIG. 9. In addition at the DOOH display Intel's AIM suite will provide real time demographic information allow the final message to change according to the viewer that is watching the display. In this module the Media Objects are downloaded to the player as opposed to residing in the cloud. This will increase response time and provide delivery of the final message to the viewer immediately after the analysis is completed. Estimated elapsed time is 5 seconds.

Each Media Object for the specific type of network is downloaded to the media players hard drive, with AIM provides the demo information. Generally the process operates as follows: First the DOOH Module receives the demo information. Then, the DOOH Module assembles the final “Media Message” based on the demo information. The DOOH Module delivers the final “Media Message” to the software player (Open Splash). The software player then plays back the “Media Message” to the display.

### Media Mapping PC/INTERNET

Media Mapping for PC/INTERNET is a module that addresses the issues of creating a final message from the Media Objects for PC/INTERNET that is relevant and appropriate for the specific type of user/demo. In this module the media will be created within the DME cloud and will send the appropriate final message to the PC/INTERNET.

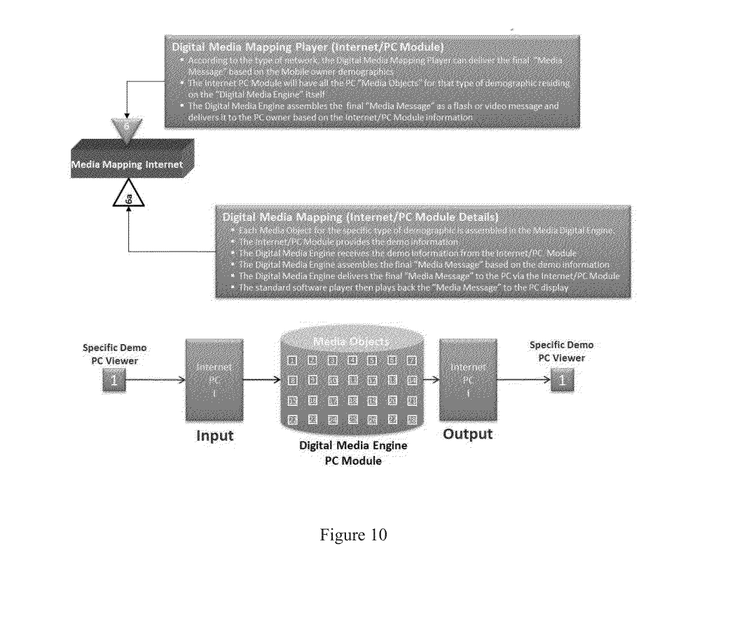

FIG. 10 illustrates this module. The module operates as follows: Digital Media Mapping (Internet/PC Module Details): Each Media Object for the specific type of demographic is assembled in the Media Digital Engine. The Internet/PC Module provides the demo information. The Digital Media Engine receives the demo information from the Internet/PC Module. The Digital Media Engine assembles the final “Media Message” based on the demo information. It then delivers the final. The Digital Media Engine delivers the final “Media Message” to the PC via the Internet/PC Module. The standard software player then plays back the “Media Message” to the PC display.

### Media Mapping Planner Module

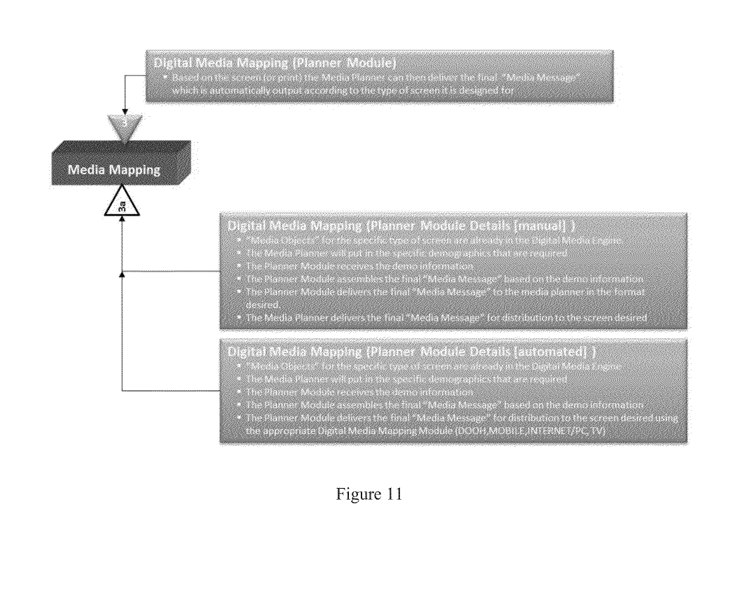

Agency planners are key to the purchasing of media across the digital landscape. The Media Mapping Planner Module is design to be a useful interface for the media planner to access final messages for any platform. This put the media at the fingertips of the planner so that they can actually buy and deliver media to the associated platform. This will occur in two instances; manual and automated. FIG. 11 illustrates this module.

In manual mode the Media Mapping Planner Module operates as follows: “Media Objects” for the specific type of screen are already in the Digital Media Engine. The Media Planner puts in the specific demographics that are required. The Planner Module receives the demo information. The Planner Module assembles the final “Media Message” based on the demo information. The Planner Module delivers the final “Media Message” to the media planner in the format desired.

In automated mode, the Media Mapping Planner Module operates as follows: “Media Objects” for the specific type of screen are already in the Digital Media Engine. The Media Planner will put in the specific demographics that are required. The Planner Module receives the demo information. The Planner Module assembles the final “Media Message” based on the demo information. The Planner Module delivers the final “Media Message” for distribution to the screen desired using the appropriate Digital Media Mapping Module (DOOH, MOBILE, INTERNET/PC, TV, etc.). Then the Media Planner delivers the final “Media Message” for distribution to the screen desired.

### Media Mapping Virtuality

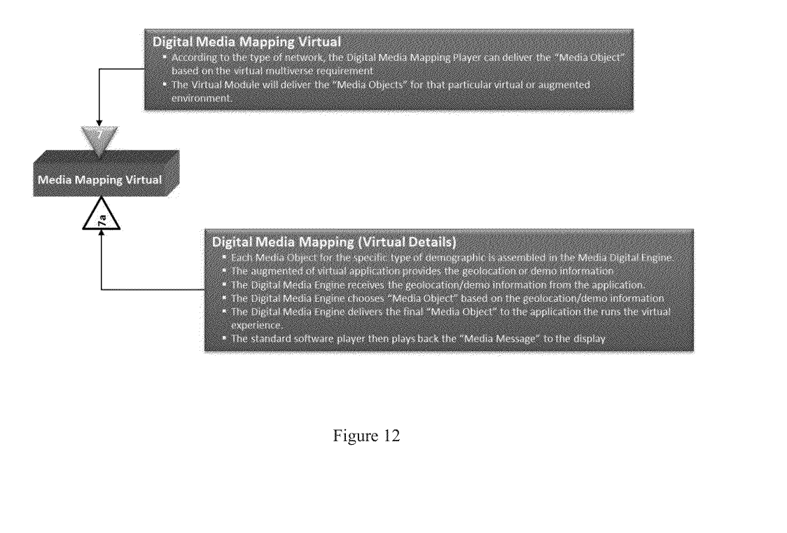

In the new world of Augmented Reality and Virtual Worlds the DME must be able to map to these unique experiences. Taking Media Objects and mapping them to these realities is the goal. FIG. 12 illustrates this module. In more detail: Each Media Object for the specific type of demographic is assembled in the Media Digital Engine. The augmented of virtual application provides the geolocation or demo information. The Digital Media Engine receives the geolocation/demo information from the application. The Digital Media Engine chooses “Media Object” based on the geolocation/demo information. The Digital Media Engine delivers the final “Media Object” to the application the runs the virtual experience. The standard software player then plays back the “Media Message” to the display.

### Characteristics of Media Messages

Every final message created has characteristics that are fundamental for creation and delivery of the message:

1. Creation—The creative process in which producers will produce media

2. Storage—A place where the media created is readily available and easily accessed

3. Message—The key communication ideas of the product or service

4. Story—The script idea, concept and vehicle by which the messages will be delivered.

5. Assets—that are created

6. The delivery of media to the appropriate screen with the relevant experience for the viewer in demographic, cultural and geographic manners.

### Focus Areas

There are eight fundamental areas that the DME architecture addresses:

1. Advertising

2. Virtual/Reality Multiverse

3. User Generated Content (UGC)—consumers at large and educational experience

4. Ad Effectiveness

5. Security

6. Compatibility—open API's, delivery platforms, asset management systems (technology and creative), creative systems and tools

7. Automation—using artificial intelligence methods to automate delivery of relevant messages

8. Measurement—effective measurement and feedback of messages

### Advertising

The DME addresses the problems associated with creating media within silo mind sets. Typically media within the agency/brand world is created in silos for the type of screen that is associated with. Throughout the years we have added each type of display method.

The advertising message is really on the verge of becoming a marketing experience. Whereas it is no longer just a simple linear final message delivered. Advertisers are facing an increasingly inefficient cross-platform supply chain where matching their messages with quality content and audiences is becoming more difficult. Enormous, unnecessary cost is incurred across the content and advertising value chain because of duplicate, manual data entry and the constant necessity to map one asset identifier to another.

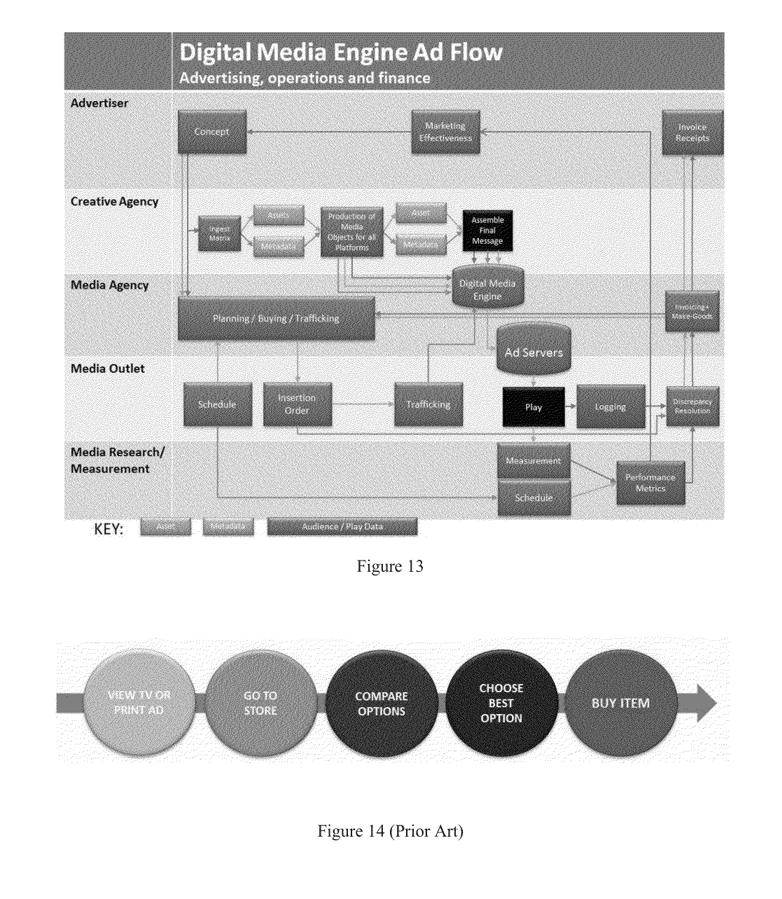

FIG. 13 illustrates the media ad flow process.

The work flow path to deliver ads to a media platform is riddled with compliance issues. By standardizing media throughout the advertising supply-chain across distribution platforms and channels, we anticipate that a number benefits can be realized. From concept it is critical to deliver relevant media to the right audience at the right screen. It is not a matter of transcoding a TV ad to work on mobile or a tablet, it is creating media that is truly portable across the ecosystem of the entire advertising work flow. In the above diagram the DME sits at that critical juncture of when the media is created and assembled into a Final Message that is appropriate for the correct experience. Although the above model is more traditional in the way television is delivered it does address the core issues of tracking bite size content which is then tracked as Final Messages to deliver the absolute desired experience for the audience. This same model is repeatable across internet, mobile and DOOH.

### User Generated Content (UGC)

To address content created by users it is important that we understand the interaction and how and what the user does when he/she generates their own content in relationship to brands and social engagement. We must also understand how one utilizes the explorer experience during the education process and how one creates multi-media reports to demonstrate ones understanding of the subject matter.

### UGC Consumers at Large

Brand Communications—Brands are trying to engage consumers in a number of ways. The path to purchase is no longer linear in nature. The challenge for today brand is how does one create a seamless experience across a chaotic landscape of interconnected and demanding consumer? What used to a few well-choreographed touch points in a very linear store-dependent advertising-inspired purchases has changed dramatically with the advent of more screen types.

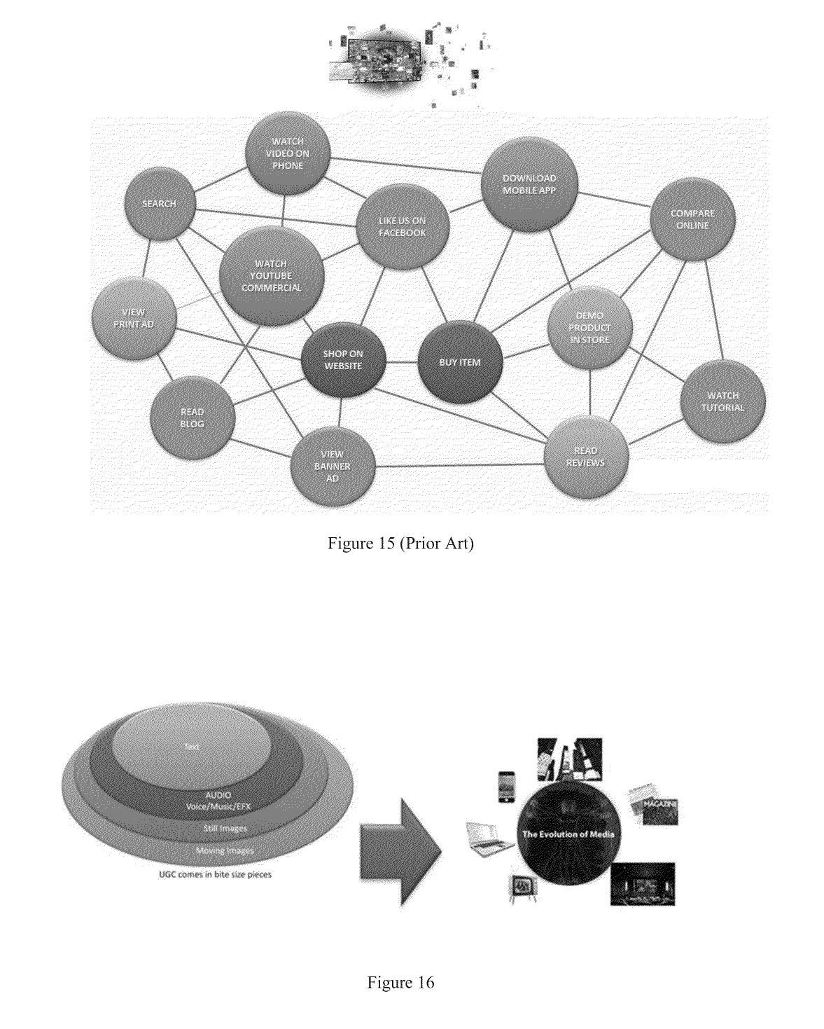

A typical prior process is illustrated in FIG. 14. Today with a proliferation of engagement digital touch-points the purchasing behavior is non-linear and omni channel, for example, as illustrated in FIG. 15.

Today with a proliferation of engagement digital touch-points the purchasing behavior is non-linear and Omni channel.

Social Communications

During this process consumers are asked to generate content in a variety of different ways. They are asked to write a short piece of copy or a complete review or load a photograph, or even a video. They are even asked to like the brand/product on face book. Capturing and tracking this content, categorizing it and then using it is a challenge among all brands. The DME will have open API's that will address the social user generated content to bring that content into Digital Mapping Process to each individual screen as appropriate. The DME architecture supports user generated and tagged content in such a manner that a brand will be able to use the content and become part of the Brands effort to engage the consumer.

### UGC and Education

The educational process is changing. In yesterday's world the process was again very linear in nature. The teacher created a curriculum relying on experts and then taught the student. In today's world the student is now an explorer of the information highway and has access to an incredible amount of information including the experts themselves. Unfortunately this is not true in most cultures where access to information is limited by either connectivity or governments.

The process of creating a multimedia report based on the information available has changed dramatically. The tools for a student to create new versions of final messages while integrating their own content is a challenge. In days of the just text, this was done by reading and siting the authors work with protocols and was easily tracked. In today's wild digital landscape this has all but disappeared.

The challenge is how does one take the broad based expert's content that is available and demonstrate an understanding by creating a new multimedia version with the students input and adding their own user generated content.

The DME architecture supports user generated content for educational uses. The architecture will be able to ingest small bite size user generated content (which is typically how a consumer creates/interacts with media). In much the same way the architecture supports the creative professional process the user generated process will follow the Ingest Media work flow allowing the user to tag their own content as Media Objects with a variety of fields. The final message can then be authored easily form the Media Objects in any format for any screen. FIG. 16 illustrates a media ad flow process.

### Media in Multiverse

Author B. Joseph Pine II and Kim Korn recently publish a book entitled Infinite Possibility—Creating Customer Value on the Digital Frontier. In this ground breaking work they describe what is referred to as a Multiverse which categorizes eight primary intersections between the physical and virtual world. The DME is designed to help provide media for interactive experiences that fuse these real and virtual realms. This is an area that the DME will address in its architecture as brands move from advertising to creating marketing engagements.

In the multiverse, there is two realms Real Orientation and Virtual Orientation. Within each of these areas there are four categories of Orientation;

Reality—Rich experiences in our real world. (example walk in the park)

Augmented Reality—Enhancing the World around us with Digital Content. (example GPS)

Alternate Reality—Alternate reality game as an interactive drama that plays out online and in real world spaces taking place over several weeks or months in which many work collaborative to solve the game.

Warped Reality—Experiences that manipulate time in some way (example Renaissance Fair)

Physical Virtuality—Taking reals world object and designed them virtually. (example 3D printing)

Mirrored Reality—Virtual experience that is tethered in reality. (example Google Flu Trends)

Augmented Virtuality—Using real devices to enhance the virtual experience (example Wii Control)

Virtuality—Virtual worlds (example second life, face book).

### Ad Effectiveness

In the industry of neuro-marketing and ad testing there lies a problem where testing adverts to the public is very difficult due to the way in which media is created. Because media is created as final messages with a target platform envisioned, it is difficult to re-produce the media to make changes in colors, icons, etc. When using the DME, some Media Objects will have the ability to be edited to then effectively change the entire final message on the fly. These may be even demographic, cultural and geographic changes that will directly deliver more relevant final messages. With feedback from AVA in the DOOH category, portions of Media Objects could then be edited to accommodate feedback.

True Ad effectiveness also relies upon the measurement and results. As these are measured the final message can easily be changed if one needs to only change a single Media Object and the output a new final message. The ability for an agency or neuromarketer to change the final message is critical to help them truly deliver the most effect advertising possible while remaining very cost efficient.

### Security

Seamless streaming of digital media across a broad landscape of platforms is built on an Enterprise level end-to-end security framework. Seamlessness, connectedness and scalability are critical requirements for the Digital Media Engine but this opens users to a vast array of security threats. This applies to the entire workflow of the Digital Media Engine. Broad-based security and risk management are critical requirements of the architecture of the Digital Media Engine. What is required is a single agent deployment with customizable policy enforcement to secure the environment and keep it protected. The security framework must identity immediate threats and vulnerabilities to diagnose and respond to security events as they happen. In addition, the security system needs to be able to update thousands of end points in minutes. The key criteria of the security platform are end to end visibility (security intelligence across all endpoints, data, mobile and networks), simplified security operations (automation capabilities that reduce the cost and complexity of security and compliance administration) and an open, extensible architecture.

Based on the requirements of the security framework for the Digital Media Engine, the McAfee ePolicy Orchestrator (ePO) appears to be a comprehensive and scalable security management framework. ePO offers unifying security management through an open platform and will connect security solutions to the Digital Media Engine infrastructure to strengthen protection.

### Compatibility

Interoperable: no prevalent asset identification methodology in use today, the vision would be most simply fulfilled with a single ID solution supported by domain-specific metadata. However, today's media landscape includes several prevalent asset ID systems, and as such, it is critical that DME be designed so that these currently incompatible systems become fully interoperable, at a layer transparent to the people, processes and technologies involved in managing assets, and transmitting and exchanging asset-related information.

Technology standards must be created so that IDs can be permanently linked to their associated assets without degrading quality. Extensible: DME standards must be capable of identifying multiple content types, versions and formats, and should be designed flexibly to accommodate emerging and future media asset types. Open and global: DME must be an open standard. It must be governed by registries accessible to all ecosystem participants and suppliers on a world-wide basis, and adhere to standards that industry companies, including technology suppliers, can utilize across a global footprint.

Currently entities use active content watermarking to embed the identifier “within” the assets, passive fingerprinting to be able to “find” the assets and then discern their identities, and/or tagging to transmit information about assets between content servers and their proprietary logging databases. Most of the tagging occurs at the final message side of the equation for distribution. Four organizations have Registration Authority for final messages. These are not set up to handle granular, bite size media or Media Objects.

### Open API's

API or Application Programming Interface will be an integral part of compatibility between delivery platforms, but also other creative tools that allow media to be manipulated, edited and layered. There are areas that API's will be applied: Creative Tools, Agency Buying and Planning Software, 3. Playback software standard media formats, Content management systems like Open Splash, and OpenSocial API's will be used for internet compatibility like Wikimedia commons, or Flicker.

### Standardization of Media

“Ad-ID and the AMWA have efforts underway that enable, accelerate, and support File-based advertising workflows. The AMWA “Commercial Delivery File Format” (AS-12), also known as the “Digital Commercial Slate” which will begin trials in early 2012, aims to insure that the same identifier should travel down through the entire commercial's lifespan, thus reducing rekeying, improving workflow, and establishing a firm foundation for reporting and analytics across all platforms.”

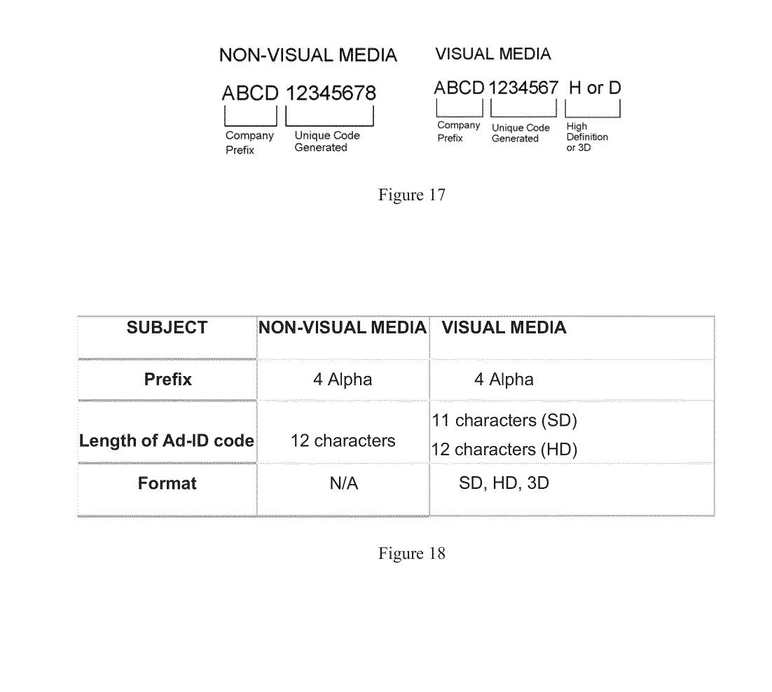

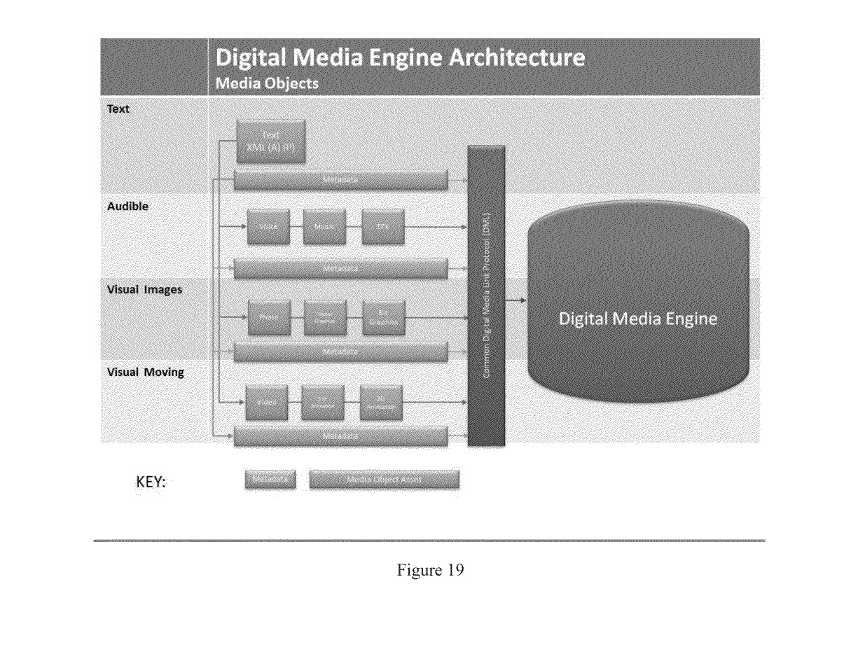

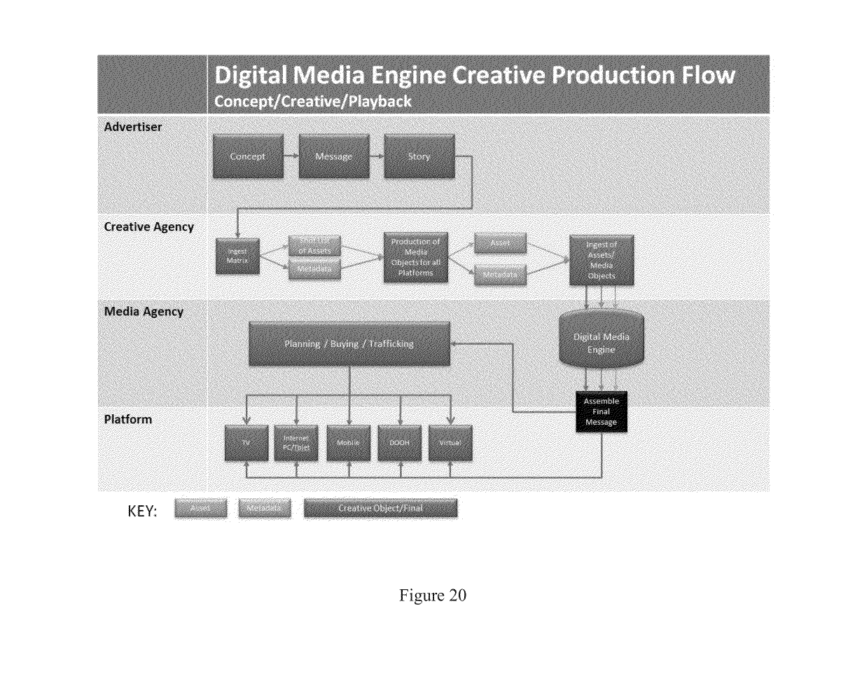

Although the DME is at a granular level the DME will adopt the standards of final messages and tie into the current adopted standards that the Ad-ID Structure which is shown in FIG. 17.

### Prefix

The Prefix is a four-letter combination that identifies an advertiser and/or the advertiser's product. All existing ISCI prefixes can be grandfathered into Ad-ID. Advertisers without an ISCI prefix need to obtain a new Ad-ID company prefix.

### Middle Four Characters

Ad-ID offers flexibility in the manner an advertiser can have the middle four characters generated. The format for a given Ad-ID is established at the time the Prefix is initially licensed and cannot be changed after it is set.

4 Digit Sequence: All 4 characters will be used to count the number of Ad-IDs issued under this prefix. These are assigned automatically when the Ad-ID is created.

Example: ABCD 0001 0000, ABCD 0002 0000 to ABCD 9999 0000

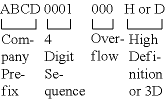

1 Digit Year+3 Digit Sequence: The first digit is the last number in the current year. The last 3 digits are used to count the number of Ad-IDs issued under this prefix. These are assigned automatically when the Ad-ID is created.

Example (using the year 2011): ABCD 1001 000, ABCD 1002 000 to ABCD 1999 000.

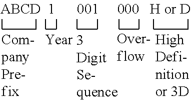

3 Digit Sequence+1 Digit Year: The first 3 digits are used to count the number of Ad-IDs issued under this prefix. The last digit is the last number in the current year. These are assigned automatically when the Ad-ID is created.

Example (using the year 2011): ABCD 0011 000, ABCD 0021 000 to ABCD 9991 000.

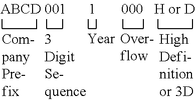

Custom: The sequence of 4 characters may be any combination of letters or numbers and are assigned manually by a user at the time the Ad-ID is created. If a user enters a sequence that is a duplicate of another Ad-ID, the system will increment the overflow characters.

Example: ABCD 1Y7W 0000, ABCD EI30 0000, ABCD 238Q 0000, etc.

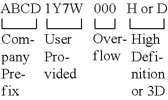

### Automation

Using Artificial Intelligence methods to automate delivery of relevant messages.

AI is phase III of the DME project. Within five years it is estimated that with proper adoption some DME's could contain over 100 Million Media Objects. Using AI, the process automating the Media Ingest of Media Objects and authoring final messages and then delivering them to relevant screens is the holy grail of the DME project. Producing creative media will never take second place to AI, but metadata and attributes of each Media Object can drive many automated processes. Reducing the manual steps and limiting human intervention, as well as the reducing duplication efforts, are key components. With the reduced duplication of effort, its two main characteristics—extra cost and increased errors—are diminished as well.

The first project that will drive this is in the DOOH industry and using AIM and AVA to begin to deliver relevant media to the exact user. The DME as a system will be able to perceive the environment of where the final message will play and take actions to deliver the right Media Objects in the right Final Message to the right display and finally to the right viewer.

### Measurement

Given the incredibly rapid growth of consumer digital touch-points (online, mobile & interactive digital signage) creating a proliferation of non-linear, omni-channel points of purchase, retailers and brands must drive timely, relevant and meaningful content to the consumer anytime, anywhere. And it must maintain an engaging and ongoing relationship with the consumer at an optimal ROI. The Digital Media Engine is a critical component to help brands and retailers achieve this objective but without effective measurement tools across all platforms, ROI tracking is

Advertisers are used to having a symbiotic relationship with traditional media partners and each side understands the other's roles. This symbiosis hasn't developed yet in on-line advertising where audiences, mindsets and behaviors of in-home TV viewers drastically differ from online. Also, 28 cents of every dollar spent online is lost to the cost of producing online ads, versus 2 cents in television, leaving much less of the relative budget for buying impressions.

The solution to these issues lies with the Digital Media Engine. First, the Digital Medial Engine will help reduce the cost of producing online and mobile ads by up to 3 times. The ability to measure the cost of media production is a critical element to measuring overall ad effectiveness. I would have also added over $5 billion of net ad revenue from media production savings. More importantly, using the Digital Media Engine content production and planning methodology will allow media producers to build context into their online and mobile campaigns consistent with TV. They can then charge premium CPM's to appear alongside it and the marketers get their desired audience(s)—consumers willing to pay for their brands.

### Architecture

Fundamentally the Architecture is based on the ability to create Media Objects that will be portable between the types of media authored. Initially the media objects will reside in the DME and then pulled into other common creative tools to author the final message. The final message will also reside within the DME. Ultimately we believe that the some of the creative tools for final assembly can reside within the DME with both manual and automated assembly of messages. To accomplish the interoperability of Media Objects we believe that within the digital constraints of the media itself is a common Digital Media Link can be created to allow for layering and timing of Media Objects. Typically today tools for creating media are very 2D. Very flat in nature with timelines and tracks. We believe that using a Digital Media Link methodology we can create Final Media Messages using Media Objects that will be interactive, layered and 3 dimensional, and be seamlessly portable to any platform. The creative process is following trends that are in play currently. Producing small bites size pieces of media. Separating the creation process from the platform it will be played on is the key. The DME will support the initial process of breaking down the story and messages to granular Media Objects. The DME will provide a shot list of media that needs to be acquired. All the assets on the shot list will have metadata attached. Once the production of the media is completed, then the media is ingested into the DME and is attached to the metadata as a Media Object. Then one can manually author using current production tools and applications. The DME will in addition provide automated delivery of final messages to the appropriate platform.

The Areas of Platform Software that the system will be built upon are: HTML 5, SVG-High Level-Import Export-Interactive-Medium Animation, Canvas-Low Level-High Animation-Java Script Centirc, Java Script, Application Cache in HTML 5—for storing local files on media players or mobile, and XMP-Open which is an industry initiative to advance XMP as an open industry and promote widespread adoption and implementation. Adobe XMP provides a standard XML envelope for metadata, defines an easy-to-implement subset of RDF, and specifies the mechanism for embedding metadata into each media asset type.

It is to be understood that the examples and embodiments described above are for illustrative purposes only and that various modifications or changes in light thereof will be suggested to persons skilled in the art and are to be included within the spirit and purview of this application and scope of the appended claims. Therefore, the above description should not be understood as limiting the scope of the invention as defined by the claims

What is claimed is:

1. A system and methodology for automatically assembling digital media objects located in a data base and transmitting the completed assembled media message via a network to a display based on the attributes of that particular type of display classification, whether it is a movie display screen, television display screen, personal computer display screen, mobile phone display screen, digital signage display screen, kiosk display screen or any other type of display screen that is known or unknown.

2. The system and methodology for automatically assembling digital media as in claim 1 wherein the data base server is configured to receive keywords, a supplemental set of keywords, and metadata in a communication signal, wherein the keywords, supplemental set of keywords, and metadata are related to the classification type of display it is transmitted to. This information can also include display classification and the type of use of the display, and the processor is configured to send a completed media message based on the set of keywords and the supplemental set of keywords.

3. The system and methodology for automatically assembling digital media in claim 1 wherein each media object is configured to have keywords, supplemental set of keywords and metadata in a communication signal, wherein the keywords, supplemental set of keywords and metadata are related to the classification type of display it is transmitted to, and wherein this information can also include display type and the type of use of the display, and the processor is configured to send a completed media message based on the set of keywords and the supplemental set of keywords.

4. The system and methodology for automatically assembling digital media in claim 3 wherein the media objects in the automated assembled message have supplemental keywords and metadata to target specific type of uses within a particular classification of displays.

5. The system and methodology for automatically assembling digital media in claim 2, wherein the data base server is configured to receive sub-supplemental keywords and metadata to target specific type of uses within a particular classification of displays.

6. The system and methodology for automatically assembling digital media in claim 1, wherein the memory is configured to be coupled to a server, which is remote from the display type, and the server is configured to serve the completed media message to the display via a communication signal.

7. The system and methodology for automatically assembling digital media in claim 3 wherein the server is configured to be coupled to a communication system via a network and serve the complete assembled media message to the communication system via the network for serving the automatically assembled media message to the transceiver via the communication signal, which delivers the media message.

8. The system and methodology for automatically assembling digital media in claim 2, wherein the displayable information includes any type of media information.

9. The system and methodology for automatically assembling digital media in claim 2 wherein the data base server is configured to receive a supplemental set of keywords and metadata in a communication signal, wherein the supplemental set of keywords and metadata are related to the location of the screen and demographic information of people who are viewing the display it is transmitted to.

10. The system and methodology for automatically assembling digital media in claim 3 wherein each media object is configured to have a keyword, supplemental set of keywords and metadata in a communication signal, wherein the keywords, supplemental set of keywords and metadata are related to the classification type of display it is transmitted, the information including at least some of location of the display and the demographic information of people who are viewing the display, and the processor is configured to send a completed media message based on the set of keywords, the supplemental set of keywords and metadata.

11. The system and methodology for automatically assembling digital media in claim 1, wherein at least one of the keywords in the set of keywords is associated with image information included in the displayable information.

12. The system and methodology for automatically assembling digital media in claim 7 wherein the image information includes any type of media message.

13. The system and methodology for automatically assembling digital media in claim 1 wherein the transceiver is configured to receive a supplemental set of keywords and metadata in a communication signal, wherein the supplemental set of keywords and metadata are relevant to a location at which the display is located.

14. The system and methodology for automatically assembling digital media in claim 1 wherein the system learns to automatically identify the specific display type and gather data from the display type and intelligently deliver media messages that are relative to the display classifications, types, and uses.

15. The system and methodology for automatically assembling digital media in claim 1 wherein the media system can also recognize objectives of a media campaign and intelligently choose the correct media objects to assemble and deliver a media message for any type of display classification, type and use.

16. The system and methodology for automatically assembling digital media in claim 1 wherein the system learns to automatically identify objectives of the media objects and gather data from all media objects put into the system and intelligently deliver media messages that are relative to the objectives of a specific media message campaign across any display classification, type, and use.

17. The system and methodology for automatically assembling digital media in claim 1 wherein the system learns using artificial intelligence software to automatically identify type of viewer by at least one of demographics, age, geolocation, ethnicity, and gender, assemble them and deliver a complete media message to that viewer based on the attributes of that individual and audience and type of display classification, type and use.

18. The system and methodology for automatically assembling digital media in claim 1 wherein the system learns using artificial intelligence software from input and will make decisions based on; more data gathered to create an intelligent media message that changes over time; and individual characteristics of the viewer and viewer type; and display classification, type and use.
